(19) United States
(12) Patent Application Publication
(10) Pub. No.: US 2025/0037896 A1
(43) Pub. Date: Jan. 30, 2025

(54) SYSTEMS AND METHODS FOR MEMS-BASED SCALABLE LARGE FIELD-OF-VIEW PARALLEL QUANTUM GATE CONTROL SYSTEM

(71) Applicant: IonQ, Inc., College Park, MD (US)

(72) Inventors: Joachim WELTE, Carrboro, NC (US); Kai Makoto HUDEK, Hyattsville, MD (US)

(21) Appl. No.: 18/785,919

(22) Filed: Jul. 26, 2024

Related U.S. Application Data
(60) Provisional application No. 63/516,275, filed on Jul. 28, 2023.

(51) Int. Cl. G21K 1/00; B82Y 10/00; G06N 10/40

(52) U.S. Cl. CPC G21K 1/003; G06N 10/40; B82Y 10/00

(57) ABSTRACT

Aspects of the present disclosure relate generally to systems and methods for use in the implementation and/or operation of quantum information processing (QIP) systems, and more particularly, to various aspects of optical addressing systems configured to individually address multiple ions of a chain of ions trapped within an ion trap. In some aspects, the trapped ions have non-equidistant spacing.

### CROSS-REFERENCE TO RELATED APPLICATION

This application claims the benefit of U.S. Provisional Patent Application No. 63/516,275, filed Jul. 28, 2023, and hereby incorporates by reference herein the contents of this application.

### TECHNICAL FIELD

Aspects of the present disclosure relate generally to systems and methods for use in the implementation, operation, and/or use of quantum information processing (QIP) systems.

### BACKGROUND

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, control, and/or functionality of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of optical addressing systems configured to individually address multiple ions of a chain of ions trapped within an ion trap. In some aspects, the trapped ions have non-equidistant spacing.

In some aspects, a quantum information processing (QIP) system includes a laser source configured to produce one or more addressing beams, a first mirror array, and a second mirror array. The first mirror array is configured to switch the one or more addressing beams between one or more channels. Each of the one or more channels is aligned with one or more qubits in an ion trap. The first mirror array is configured to direct the one or more addressing beams to the second mirror array. The second mirror array is configured to change a tilt of the one or more addressing beams relative to the one or more qubits in an ion trap.

In some aspects, a quantum information processing (QIP) system includes a laser source configured to produce one or more addressing beams, a first mirror array, and a second mirror array. The first mirror array is configured to change a position of the one or more addressing beams relative to one or more qubits in an ion trap. The first mirror array is configured to direct the one or more addressing beams to the second mirror array. The second mirror array is configured to change a tilt of the one or more addressing beams relative to the one or more qubits in the ion trap.

In some aspects, a quantum information processing (QIP) system includes a processor and a memory. The processor is configured to execute computer executable instructions in the memory to command one or more first actuators coupled to a first mirror away to switch one or more addressing beams produced by a laser source between one or more channels. Each of the one or more channels is aligned with one or more qubits in an ion trap and wherein the first mirror array is configured to direct the one or more addressing beams to a second mirror array. The processor is configured to command one or more second actuators coupled to a second mirror array to reposition the one or more addressing beams to change a tilt of the one or more addressing beams relative to one or more qubits in an ion trap.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions of a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates a schematic representation of a M×N system configured to dynamically and flexibly switch M beams onto N different optical addressing channels configured to address N qubits in accordance with aspects of this disclosure.

FIG. 5 illustrates a schematic representation of a N×N system configured to position N beams onto N qubits in the ion trap and correct distortions of the addressing beam in accordance with aspects of this disclosure.

FIG. 6 illustrates a schematic representation of a system configured for both M×N switching and N×N distortion correction configured to address multiple qubits in accordance with aspects of this disclosure.

FIG. 7 illustrates a method for directing (or redirecting) one or more beams onto one or more qubits in an ion trap in accordance with aspects of this disclosure.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well-known components are shown in block diagram form, while some blocks may be representative of one or more well-known components.

Quantum computing systems involve addressing ions trapped in a linear crystal and ion chain or in a two-dimensional lattice arrangement in which N beams are arranged in a O×P matrix to address, e.g. N=O×P neutral atom qubits in a 2D lattice. However, addressing individual trapped ions with non-equidistant spacing can be challenging. For example, the systems described below use a number N of evenly spaced optical addressing channels to address a number N of trapped ions in an ion chain. However, the spacing between the trapped ions may be non-equidistant. This can cause the addressing beams to address the trapped ions in a non-optimal manner. In general, for purposes of this disclosure, addressing ions in an “optimal” manner means that the individual beam is telecentric and centered on the respective ion with the correct tilt and the like, such that the beam is not missing the ion or only partially hitting the ion, for example. Telecentric beams are optimal because they are first-order insensitive to certain alignment errors, like defocus and tilt. Telecentricity removes any projection of the difference of the k-vector of the counterpropagating or copropagating Raman beams on the ion chain axis, which would lead to momentum transfer to the ions and heating. Also, telecentric systems are more robust to drifts along the optical axis, because the spacing between the beams remains the same and the beams are still centered (albeit slightly defocused) on the ions.

For example, some conventional systems may use multi-channel acousto-optic modulators (AOMs) to direct beams to each of the trapped ions. However, such systems typically have restricted fields of view and the beam spacing produced by such a system cannot be optimally mapped onto non-equidistant ion locations. Further, such systems have a limited number of channels that can be used to direct beams onto particular ions. This can make such a system difficult to use for longer length ion chains. In such systems, only a subset, typically two, of the channels are used to address qubits at any particular time, meaning that the other channels are simply turned off, which results in a loss of laser power. Additionally, the required laser power scales with the number N of qubit locations that need to be addressable.

Other conventional systems may use a microelectromechanical systems (MEMS)-based scanner to flexibly map addressing beams onto an ion chain or a pair of acousto-optic deflectors (AOD) to map at least two beams onto an ion chain. However, such systems can be difficult to scale up because running a number M of parallel single qubit gate operations requires increasing the available laser power in the system by a number M²/2. This is a consequence of the requirement of “optimal” mapping and the brightness theorem. Therefore, the number of parallel qubit gate operations in such a system is limited by the available laser power.

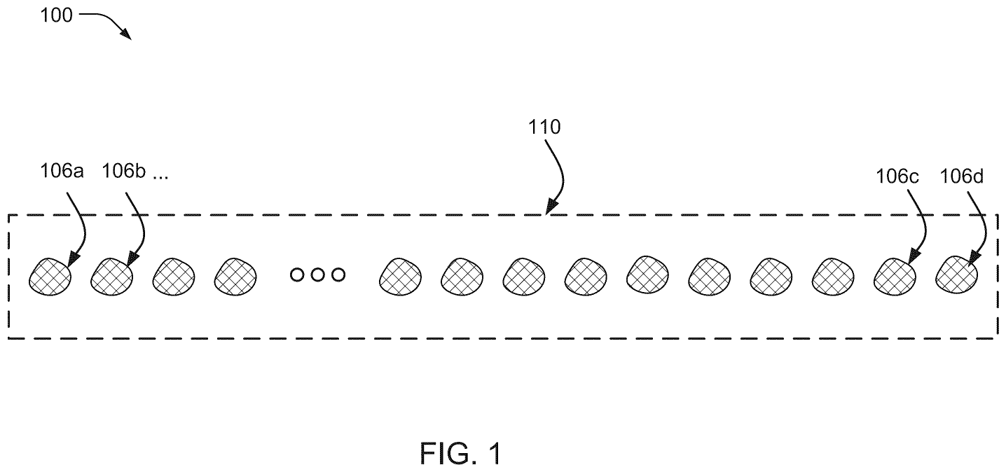

Solutions to the issues described above are explained in more detail in connection with FIGS. 1-6, with FIGS. 1-3 providing a background of QIP systems or quantum computers, and more specifically, of atomic-based QIP systems or quantum computers.

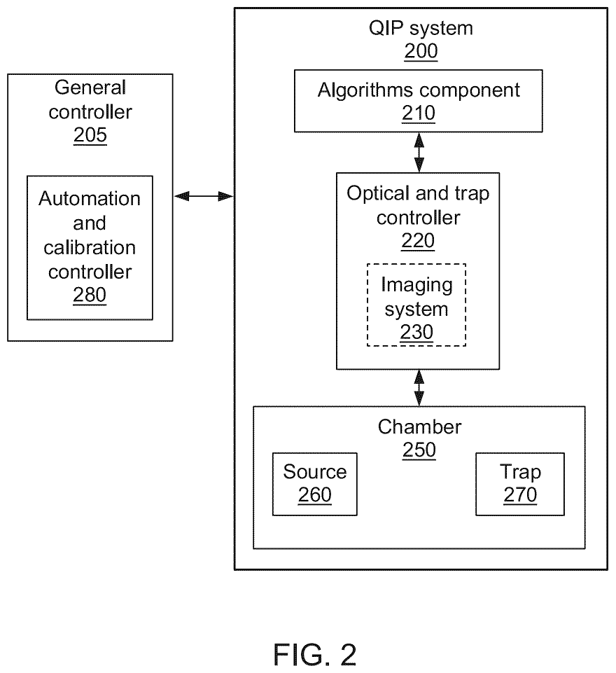

FIG. 1 illustrates a diagram 100 with multiple atomic ions or ions 106 (e.g., ions 106a, 106b, . . . , 106c, and 106d) trapped in a linear crystal or chain 110 using a trap (not shown; the trap can be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The ions 106 may be provided to the trap as atomic species for ionization and confinement into the chain 110. Some or all of the ions 106 may be configured to operate as qubits in a QIP system.

In the example shown in FIG. 1, the trap includes electrodes for trapping or confining multiple ions into the chain 110 laser-cooled to be nearly at rest. The number of ions trapped can be configurable and more or fewer ions may be trapped. The ions can be Ytterbium ions (e.g., ¹⁷¹Yb⁺ ions), for example. The ions are illuminated with laser (optical) radiation tuned to a resonance in ¹⁷¹Yb+ and the fluorescence of the ions is imaged onto a camera or some other type of detection device (e.g., photomultiplier tube or PMT). In this example, ions may be separated by a few microns (m) from each other, although the separation may vary based on architectural configuration. The separation of the ions is determined by a balance between the external confinement force and Coulomb repulsion and does not need to be uniform. Moreover, in addition to Ytterbium ions, neutral atoms, Rydberg atoms, or other types of atomic-based qubit technologies may also be used. Moreover, ions of the same species, ions of different species, and/or different isotopes of ions may be used. The trap may be a linear RF Paul trap, but other types of confinement devices may also be used, including optical confinements and non-linear confinements such as 2D and 3D lattices. Thus, a confinement device may be based on different techniques and may hold ions, neutral atoms, or Rydberg atoms, for example, with an ion trap being one example of such a confinement device. The ion trap may be a surface trap, for example.

FIG. 2 illustrates a block diagram that shows an example of a QIP system 200. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations. The quantum and classical computations and operations may interact in such a hybrid system.

Shown in FIG. 2 is a general controller 205 configured to perform various control operations of the QIP system 200. These control operations may be performed by an operator, may be automated, or a combination of both. Instructions for at least some of the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200. These calibration, testing, and automation operations may involve, for example, all or part of an algorithms component 210, all or part of an optical and trap controller 220 and/or all or part of a chamber 250.

The QIP system 200 may include the algorithms component 210 mentioned above, which may operate with other parts of the QIP system 200 to perform or implement quantum algorithms, quantum applications, or quantum operations. The algorithms component 210 may be used to perform or implement a stack or sequence of combinations of single qubit operations and/or multi-qubit operations (e.g., two-qubit operations) as well as extended quantum computations. The algorithms component 210 may also include software tools (e.g., compilers) that facility such performance or implementation. As such, the algorithms component 210 may provide, directly or indirectly, instructions to various components of the QIP system 200 (e.g., to the optical and trap controller 220) to enable the performance or implementation of the quantum algorithms, quantum applications, or quantum operations. The algorithms component 210 may receive information resulting from the performance or implementation of the quantum algorithms, quantum applications, or quantum operations and may process the information and/or transfer the information to another component of the QIP system 200 or to another device (e.g., an external device connected to the QIP system 200) for further processing.

The QIP system 200 may include the optical and trap controller 220 mentioned above, which controls various aspects of a trap 270 in the chamber 250, including the generation of signals to control the trap 270. The optical and trap controller 220 may also control the operation of lasers, optical systems, and optical components that are used to provide the optical beams that interact with the atoms or ions in the trap. Optical systems that include multiple components may be referred to as optical assemblies. The optical beams are used to set up the ions, to perform or implement quantum algorithms, quantum applications, or quantum operations with the ions, and to read results from the ions. Control of the operations of laser, optical systems, and optical components may include dynamically changing operational parameters and/or configurations, including controlling positioning using motorized mounts or holders. When used to confine or trap ions, the trap 270 may be referred to as an ion trap. The trap 270, however, may also be used to trap neutral atoms, Rydberg atoms, and other types of atomic-based qubits. The lasers, optical systems, and optical components can be at least partially located in the optical and trap controller 220, an imaging system 230, and/or in the chamber 250. The QIP system 200 may include the imaging system 230. The imaging system 230 may include a high-resolution imager (e.g., CCD camera) or other type of detection device (e.g., PMT) for monitoring the ions while they are being provided to the trap 270 and/or after they have been provided to the trap 270 (e.g., to read results). In an aspect, the imaging system 230 can be implemented separate from the optical and trap controller 220, however, the use of fluorescence to detect, identify, and label ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of what may be referred to as a processor or processing portion of the QIP system 200. That is, the trap 270 may be considered at the core of the processing operations of the QIP system 200 since it holds the atomic-based qubits that are used to perform or implement the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the optical systems and the optical and trap controller 220.

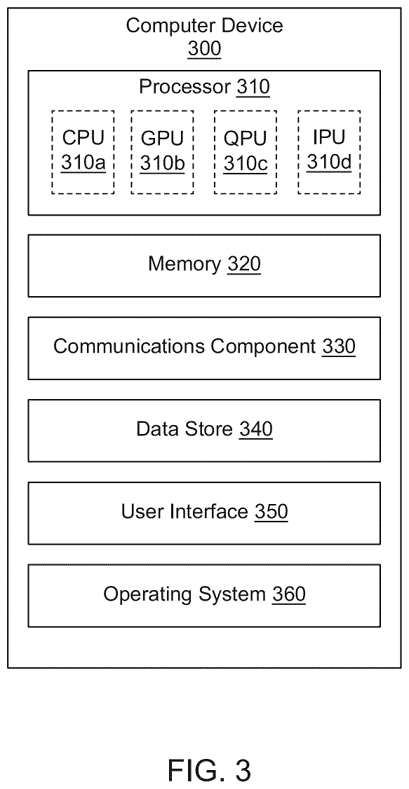

Referring now to FIG. 3, an example of a computer system or device 300 is shown. The computer device 300 may represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single processor, multiple set of processors, or one or more multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300). Quantum operations may be performed by the QPUs 310c. Some or all of the QPUs 310c may use atomic-based qubits, however, it is possible that different QPUs are based on different qubit technologies.

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In connection with the systems described in FIGS. 1-3, the aspects described herein provide a MEMS-based large-field-of view system for addressing multiple ions in a chain of trapped ions 272a . . . 272n. In general, a qubit is the basic unit of information in the quantum computing systems according to the exemplary aspects described herein. In this example, the state of the ions (e.g., trapped ions 272a to 272n) can represent qubits according to an example aspect. The aspects described herein are configured to use N equally spaced channels to map to N ions that may have non-equidistant spacing between adjacent ions. For example, based on the design of the trap 270, spacing between adjacent ions may follow a fourth order function. In such aspects, the trapped ions 272a . . . 272n positioned proximate a center of the ion chain are substantially equidistantly spaced, but the spacing between adjacent trapped ions 272a . . . 272n increases toward the end of the ion chain. In some aspects, the systems described herein can be used for parallel addressing of quantum gates. The systems described herein also may be scalable to larger chains, for example chains including more than 32 trapped ions 272a . . . 272n. Further, when addressing multiple qubits, the systems described herein may more efficiently use laser power as the scale of the system is increased.

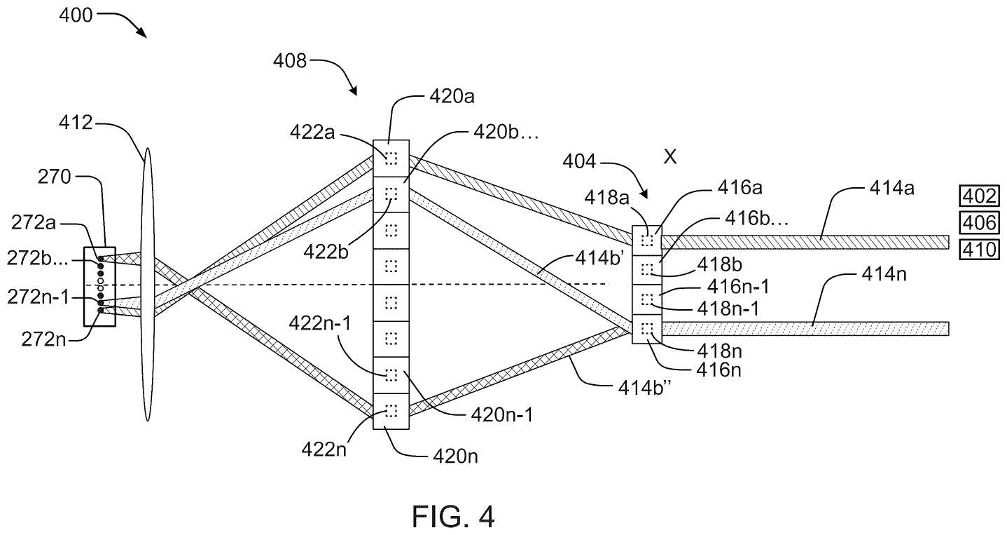

FIG. 4 illustrates a schematic representation of a M×N system 400 configured to address one or more qubits. As used herein, the variable N refers to the number of trapped ions 272a . . . 272n. The variable M refers to a number of addressing beams used by the system. The system 400 is configured to dynamically and flexibly switch M beams onto N different optical addressing channels configured to address N trapped ions 272a . . . 272n in the ion trap 270. Such a configuration can allow for simultaneous operation of M/2 2-qubit gates with laser power scaling proportionally to the number M of simultaneously existing addressing beams, while still allowing addressing of all N qubits simultaneously. In some aspects, the number M of addressing beams may be the same as the number N of optical addressing channels. In some aspects, the number M of addressing beams may be different than the number N of optical addressing channels.

In the illustrated configuration, the system 400 includes a first mirror array 404, a second mirror array 408, and a lens 412. In some aspects, the first mirror array 404 is configured to position the addressing beams 414a . . . 414n for projection onto the trapped ions 272a . . . 272n. In some aspects, the second mirror array 408 is configured to correct tilt in the addressing beams 414a . . . 414n. The system 400 may also further include one or more additional optical elements or optical relays for beam size matching, magnification, and so forth. In some aspects, one or more optical elements or optical relays may be positioned between the first mirror array 404 and the second mirror array 408. In the illustrated configuration, the system 400 further includes a source of beams 402 (e.g., a laser), an M-channel AOM 406, and an M beam-splitter, such as a diffractive optical element (DOE) 410. For example, in the configuration of FIG. 4, the system 400 is configured to receive four beams 414 (e.g., from an M-channel AOM and an M-beam splitter DOE). In operation in a QIP system, such as the QIP system 200, two systems 400 may be used. In such configurations, the second system 400 would be noncollinear with the system 400, such as on the opposite side of the ion trap 270 and symmetric to the system 400 of FIG. 4, forming M pairs of counterpropagating beams. In some aspects, the number of M pairs of counterpropagating beams may be the same as the number N of channels. In other aspects, the number of M pairs of counterpropagating beams may be different than the number N of channels.

The first mirror array 404 includes a first plurality of mirrors or groups of mirrors 416a . . . 416n. As referred to herein and unless noted otherwise, the phrase “mirrors” is intended to encompass one mirror or a group of mirrors. The first mirror array 404 is configured to project an input channel (e.g., the beam 414a . . . 414n received from the AOM) 406 to an output channel configured to direct the beam to the trapped ions 272a . . . 272n. Each of the mirrors 416a . . . 416n is coupled to an actuator, shown schematically as 418a . . . 418n configured to reposition that mirror 416a . . . 416n. In the illustrated configuration, the actuators 418a . . . 418n include MEMS actuators. The actuators 418a . . . 418n are dynamically repositionable (e.g., by the optical and trap controller 220) to direct a particular beam aligned with a particular mirror or group of mirrors 416a . . . 416n in the first mirror array 404 to a particular mirror or group of mirrors in the second mirror array 408. For example, the actuators 418a . . . 418n are configured to tune the angles of the mirrors 416a . . . 416n to map the M beams to N locations in the field of view (FOV), such as, for example, the second mirror array 408. This allows each of the M input channels to be independently mapped to any N of the output channels (e.g., via the second mirror array 408), reducing a loss of laser power that occurs in conventional addressing systems. As described in greater detail below, the N locations include the N mirrors in the second mirror array 408. During operation of the QIP system 200, the actuators 418a . . . 418n may quickly (e.g., on the microsecond scale) reposition the mirrors 416a . . . 416n to direct the beams 414a . . . 414n to address different trapped ions 272a . . . 272n. For example, in the configuration shown in FIG. 4, the mirror 416a is oriented to direct a first beam 414a to a first mirror 420a of the second mirror array 408. The mirror 416n is configured to direct a second beam 414n to a second mirror 420b of the second mirror array 408. In other configurations, the mirrors 416a, 416n can be repositioned to direct the beams 414a, 414n onto different mirrors of the second mirror array 408.

As shown in FIG. 4, the number of mirrors or groups of mirrors 416a . . . 416n in the first plurality of mirrors 416 is the same as the number M of input channels that receive the beams 414a . . . 414n. For example, in the configuration of FIG. 4, the system 400 is configured to receive four beams. In FIG. 4, the first mirror array 404 includes M mirrors or groups of mirrors 416a . . . 416n. In other configurations, the system 400 may be configured to receive more or fewer beams 414a . . . 414n. In such aspects, the first mirror array 404 may include more or fewer mirrors or groups of mirrors 416a . . . 416n. In some aspects, the plurality of mirrors 416a . . . 416n may include one mirror per input M beam 414a . . . 414n.

In some aspects, one or more optical elements or optical relays may be positioned between the first mirror array 404 and the second mirror array 408. In such aspects, the optical elements or optical arrays may be or include 4F optical relays or 2F-2F relays configured to modify the M beams 414a . . . 414n. Each of the M beams can be directed to a particular ion 272a . . . 272n by the second mirror array 408. Further, in some aspects, relays may be used to double the range of the mirror tilt.

In some aspects, one or more of the M beams may be redirected by adjusting an orientation of the particular mirror 416a . . . 416n of the first mirror array 404 that is contacted by the one or more M beams. For example, FIG. 4 shows a configuration in which the beam 414n is initially directed toward the mirror 420b of the second mirror array 408, as shown by the beam 414n′. The beam 414n′ continues to the mirror 420b of the second mirror array 408 and addresses the ion 272n-1. After the orientation of the mirror 416n has been adjusted, the mirror 416n directs the beam 414n toward the mirror 420n of the second mirror array 408, as shown by the beam 414n″. The beam 414n″ continues to the mirror 420n of the second mirror array 408 and addresses the ion 272a.

The second mirror array 408 includes a second plurality of mirrors 420a . . . 420n. Each of the mirrors or groups of mirrors 420a . . . 420n is mapped to one of the N ions 272a . . . 272n. Each of the mirrors 420 is coupled to an actuator, shown schematically as 422a . . . 422n, configured to a the particular mirror 420a . . . 420n coupled to a particular actuator 422a . . . 422n. The second mirror array 408 is configured to correct any tilt in the beam 414a . . . 414n projected onto the mirror array 408 from the mirror array 404 to reposition the beam 420a . . . 420n relative to the trapped ions 272a . . . 272n. In the illustrated configuration, the actuators 422a . . . 422n include MEMS actuators. The actuators 422a . . . 422n are repositionable (e.g., by the optical and trap controller 220) to reposition a particular mirror or group of mirrors 420a . . . 420n to direct a beam 414a . . . 414n contacting a particular mirrors or group of mirrors 420a . . . 420n to a particular one of the trapped ions 272a . . . 272n. For example, in the configuration illustrated in FIG. 4, the first mirror or group of mirrors 420a is oriented to direct the first beam 414a onto the ion 272n. The second mirror or group of mirrors 420b is oriented to direct the second beam 414n onto the ion 272n-1. This is particularly advantageous for configurations in which the trapped ions 272a . . . 272n are unevenly spaced, because the angles of the mirrors 420a . . . 420n can be customized based on the actual position of the ions 272a . . . 272n. For example, the actuators 422a . . . 422n may be configured to tune the angles of the mirrors 416a . . . 416n and the mirrors 420a . . . 420n so that the beams 414a . . . 414n are telecentric at the ions 272a . . . 272n. For example, the mirrors 416a . . . 416n may be used to tune the position of the beams 414a . . . 414n and the mirrors 420a . . . 420n may be used to tune the tilt of the beams 414a . . . 414n.

Although the mirrors 420a . . . 420n are repositionable by the actuators 422a . . . 422n, the mirrors 420a . . . 420n are repositioned more slowly than the mirrors 416 of the first mirror array 404. The speed is compensated for by the fact that the mirrors 420 need only be repositioned over small ranges. For example the mirrors 420a . . . 420n may be repositioned during a configuration sequence to align each of the mirrors 420a . . . 420n with a particular ion 272a . . . 272n. The mirrors 420a . . . 420n may also be repositioned during operation of the QIP system 200, for example to compensate for drift or changing inputs 414. In some aspects, the optical and trap controller 220 determines that a particular mirror or group of mirrors 420a . . . 420n should be repositioned in response to determining that the particular ion 272a . . . 272n is receiving less input than other ions 272a . . . 272n, is responding more slowly when flipping the qubits with the addressing beams 414a . . . 414n, has more intensity than is expected to be needed to perform an operation with the qubits, and so forth.

As shown in FIG. 4, the number of mirrors or groups of mirrors 420a . . . 420n in the second plurality of mirrors 420 is the same as the number N of trapped ions 272a . . . 272n. In some aspects, the second array 408 may be an array of round or quadratic mirrors, such that the group of mirrors 420a . . . 420n are configured to address each of the N ions 272a . . . 272n.

In an example aspect, the second mirror array 408 is provided and configured to adjust the beams 414a . . . 414n such that the beams 414a . . . 414n are telecentric with the ions 272a . . . 272n. In configurations that do not include the second mirror array 408, only a portion of the beams 414a . . . 414n may hit the ions 272a . . . 272n or the beams 414a . . . 414n may miss the ions 272a . . . 272n. Further, in configurations that do not include the second mirror array 408, there may be projection along the axis of the ion chain, which can lead to heating of the ion trap 270 and the ions 272a . . . 272n. This heating can reduce the fidelity of the operations conducted by the ions 272a . . . 272n. It is further advantageous to include the second mirror array 408 to allow both the position and the angle of the beams 414a . . . 414n to be corrected because each of the mirror arrays 404, 408 cannot correct angle and position simultaneously.

The lens 412 may be configured for beam size matching, magnification, and so forth on the beams 414a . . . 414n exiting the second mirror array 408. In some aspects, the lens 412 may be part of a larger optical relay.

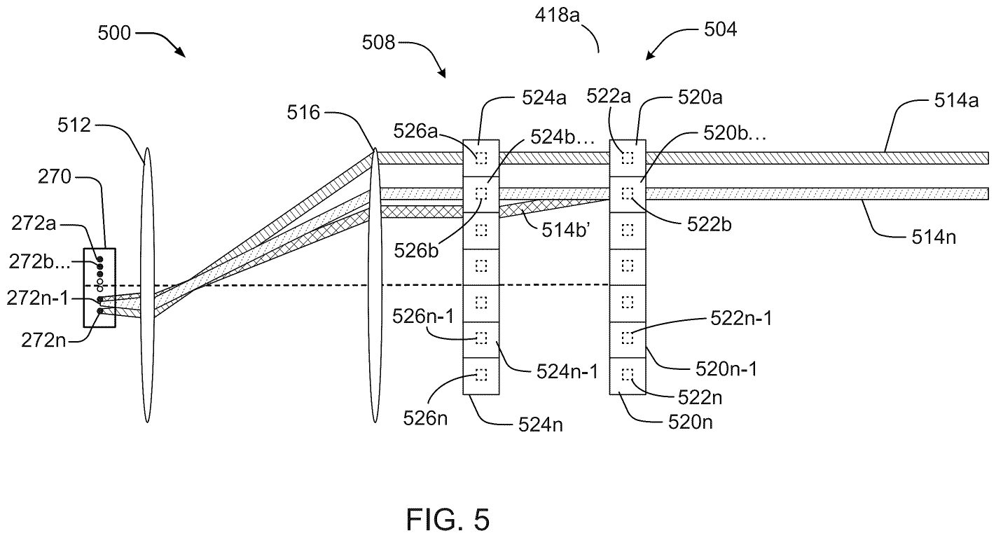

FIG. 5 illustrates a schematic representation of a N×N system 500 configured to address two or more qubits. The system 500 is configured to position N beams onto N trapped ions 272a . . . 272n in the ion trap 270 and correct distortions of the addressing beams 514a . . . 514n. The trapped ions 272a . . . 272n may have non-equidistant spacing between adjacent ions 272a . . . 272n. In the illustrated configuration, the system 500 includes a first mirror array 504, a second mirror array 508, a first lens 512, and a second lens 516. In some aspects, the first mirror array 504 is configured to position the addressing beams 514a . . . 514n beams for projection onto the trapped ions 272a . . . 272b. In some aspects, the second mirror array 508 is configured to correct tilt in the addressing beams 514a . . . 514n. The system 500 may also further include one or more optical elements or additional optical relays for beam size matching, magnification, and so forth. In some aspects, one or more optical elements or optical relays may be positioned between the first mirror array 504 and the second mirror array 508. In the illustrated configuration, the system 500 further includes a source of beams (e.g., a laser), an N-channel modulator, such as an AOM, and an N beam-splitter, such as a DOE. For example, in the configuration of FIG. 5, the system 500 is configured to receive N beams 514 (e.g., from the N-channel modulator and a N-splitter DOE). In operation in a QIP system, such as the QIP system 200, two systems 500 may be used. In such configurations, the second system 500 would be noncollinear with the system 500, such as on the opposite side of the ion trap 270 and symmetric to the system 500 of FIG. 5.

The first mirror array 504 includes a first plurality of mirrors or groups of mirrors 520a . . . 520n. Each of the mirrors or groups of mirrors 520a . . . 520n is coupled to an actuator 522a . . . 522n configured to reposition the particular mirror 520a . . . 520n coupled to the particular actuator 522a . . . 522n. In the illustrated configuration, the actuators 522a . . . 522n include MEMS actuators. The actuators 522a . . . 522n are repositionable (e.g., by the optical and trap controller 220) to reposition a particular mirror or group of mirrors 520a . . . 520n to direct a beam 514a . . . 514n to a particular mirror or group of mirrors in the second mirror array 508. For example, the actuators 522a . . . 522n are configured to tune the angles of the mirrors 520a . . . 520n to map the N beams to N locations in the field of view (FOV). As described in greater detail below, the N locations include the N mirrors in the second mirror array 508. For example, in the configuration shown in FIG. 5, the mirror or group of mirrors 520a is oriented to direct a first beam 514a to a first mirror or group of mirrors 524a of the second mirror array 508. The mirror or group of mirrors 520b is configured to direct a second beam 514n to a second mirror or group of mirrors 524b of the second mirror array 508. During operation of the QIP system 200, the actuators 522a . . . 522n may reposition the mirrors 520a . . . 520n to reposition the beams 514a . . . 514n in response to determining that the beams 514a . . . 514n are not optimally addressing the trapped ions 272a . . . 272n. For example, as shown in FIG. 5, the optical and trap controller 220 may determine that the second beam 514n is not optimally addressing the ion 272n-1. In some aspects, the optical and trap controller 220 determines that a particular mirror or group of mirrors 524a . . . 524n should be repositioned in response to determining that the particular ion 272a . . . 272n is receiving less input than other ions 272a . . . 272n, is responding more slowly when flipping the qubits with the addressing beams 514a . . . 514n, more intensity than expected is needed to perform an operation with the qubits, and so forth. In response to this determination, the optical and trap controller 220 may command the actuator 520n-1 coupled to the mirror or group of mirrors 520n-1 to reposition the mirror or group of mirrors 520n-1 to reposition the beam 514n to the position of the beam 514n′. As shown in FIG. 5, the repositioned beam 514n′ is substantially centered on the trapped ion 270n-1. Although the mirrors 520a . . . 520n are repositionable by the actuators 522a . . . 522n, the mirrors 520a . . . 520n are repositioned slowly. For example the mirrors 520a . . . 520n may be repositioned during a configuration sequence to align each of the mirrors 520a . . . 520n with a particular mirror 524a . . . 524n. The mirrors 520a . . . 520n may also be repositioned during operation of the QIP system 200, for example to compensate for drift. In some aspects, the optical and trap controller 220 determines that a particular mirror or group of mirrors 520a . . . 520n should be repositioned in response to determining that the particular ion 272a . . . 272n is receiving less input than other ions 272a . . . 272n, is responding more slowly when flipping the qubits with the addressing beam, more intensity than expected is needed to perform an operation, and so forth.

As shown in FIG. 5, the number of mirrors or groups of mirrors 520a . . . 520n in the first plurality of mirrors 520 is the same as the number N of beams. For example, in the configuration of FIG. 5, the system 500 is configured to receive N beams. In FIG. 5, the first mirror array 504 includes N mirrors or groups of mirrors 520a . . . 520n. In other configurations, the system 500 may be configured to receive more or fewer beams. In such aspects, the first mirror array 504 may include more or fewer mirrors or groups of mirrors 520a . . . 520n.

The second mirror array 508 includes a second plurality of mirrors 524a . . . 524n. Each of the mirrors or groups of mirrors 524a . . . 524n is mapped to one of the N ions 272a . . . 272n. Each of the mirrors 524a . . . 524n is coupled to an actuator, shown schematically as 526a . . . 526n, configured to reposition a particular mirror 524a . . . 524n coupled to the particular actuator 526a . . . 526n. In the illustrated configuration, the actuators 526a . . . 526n include MEMS actuators. The actuators 526a . . . 526n are repositionable (e.g., by the optical and trap controller 220) to direct a beam 514a . . . 514n contacting one a particular one of the mirrors or groups of mirrors 524a . . . 524n to a particular one of the trapped ions 272a . . . 272n. For example, in the configuration illustrated in FIG. 5, the first mirror or groups of mirrors 524a is oriented to direct the first beam 514a onto the ion 272n. The second mirror or group of mirrors 524b is oriented to direct the second beam 514n (or repositioned beam 514n′) onto the ion 272n-1. This is particularly advantageous for configurations in which the trapped ions 272a . . . 272n are unevenly spaced, because the angles of the mirrors 520a . . . 520n and the mirrors 524a . . . 524n can be customized based on the actual position of the ions 272a . . . 272n. For example, the actuators 526a . . . 526n may be configured to tune the angles of the mirrors 524a . . . 524n so that the beam 514a . . . 514n is telecentric at the ions 272a . . . 272n. Although the mirrors 524a . . . 524n are repositionable by the actuators 526a . . . 526n, the mirrors 524a . . . 524n are repositioned slowly. For example the mirrors 524a . . . 524n may be repositioned during a configuration sequence to align each of the mirrors 524a . . . 524n with a particular ion 272a . . . 272n. The mirrors 524a . . . 524n may also be repositioned during operation of the QIP system 200, for example to compensate for drift. In some aspects, the optical and trap controller 220 determines that a particular mirror or group of mirrors 524a . . . 524n should be repositioned in response to determining that the particular ion 272a . . . 272n is receiving less input than other ions 272a . . . 272n, is responding more slowly when flipping the qubits with the addressing beam, more intensity than expected is needed to perform an operation, and so forth.

As shown in FIG. 5, the number of mirrors or groups of mirrors 524a . . . 524n in the second plurality of mirrors 524 is the same as the number N of trapped ions 272a . . . 272n. In some aspects, the second array 508 may be an array of round or quadratic mirrors, such that groups of mirrors 524a . . . 524n are configured to address each of the N ions 272a . . . 272n.

The lenses 512, 516 may be configured for beam size matching, magnification, and so forth on the beams 514a . . . 514n exiting the second mirror array 508. In some aspects, the lenses 512, 516 may be part of a larger optical relay.

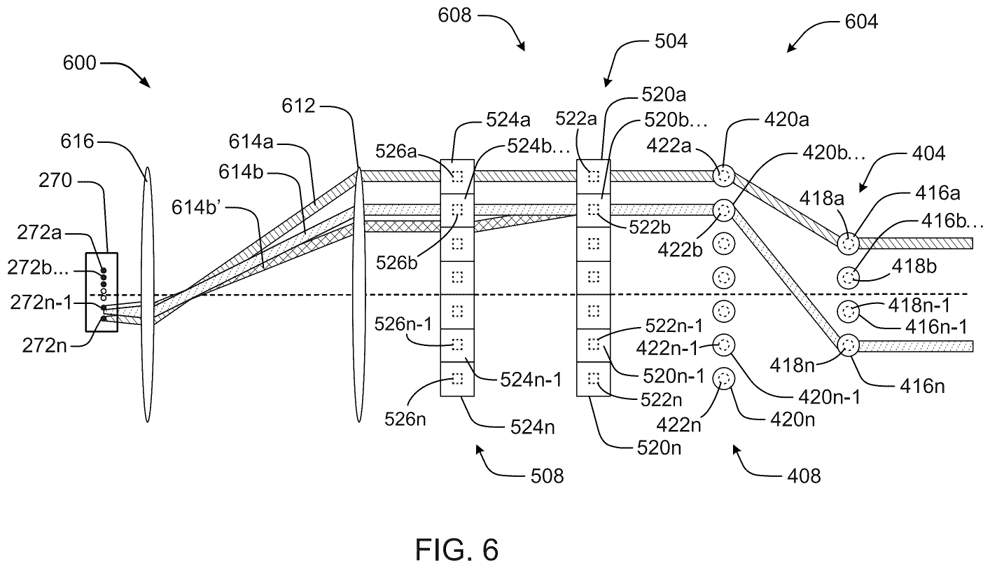

FIG. 6 illustrates a schematic representation of a system 600 configured for both M×N switching and N×N distortion correction configured to address two or more qubits. The system 600 includes a first pair of mirror arrays 604, a second pair of mirror arrays 608, a first lens 612, and a second lens 616. In operation in a QIP system, such as the QIP system 200, two systems 600 may be used. In such configurations, the second system 600 would be noncollinear with the system 600, such as on the opposite side of the ion trap 270 and symmetric to the system 600 of FIG. 6.

The first pair of mirror arrays 604 is configured to dynamically switch M beams onto N trapped ions 272a . . . 272n in the ion trap 270, for example by dynamically switching M beams onto N channels aligned with the N trapped ions 272a . . . 272n. The first pair of mirror arrays 604 is substantially similar to the first mirror array 404 and the second mirror array 408 described above with regard to the system 400. Like numbering is used for like parts between the system 400 and the system 600. The first pair of mirror arrays 604 is only described in detail herein as it differs from the first mirror array 404 and the second mirror array 408 of the system 400.

The second pair of mirror arrays 608 is configured for distortion correction of the beams 614a-614n directed onto N trapped ions 272a . . . 272n in the ion trap 270. The second pair of mirror arrays 608 is substantially similar to the first mirror array 504 and the second mirror array 508 described above with regard to the system 500. Like numbering is used for like parts between the system 500 and the system 600. The second pair of mirror arrays 608 is only described in detail herein as it differs from the first mirror array 504 and the second mirror array 508 of the system 500.

The lenses 612, 616 may be configured for beam size matching, magnification, and so forth on the beams 514a . . . 514n exiting the second mirror array 608. In some aspects, the lenses 612, 616 may be part of a larger optical relay.

In operation, the beams 414a . . . 414n travel to the first pair of mirror arrays 604. The first pair of mirror arrays 604 is configured to position (e.g., map) the M beams 414a . . . 414n onto the desired N output channels. The first mirror array 404 of the first pair of mirror arrays 604 has the same number M of mirrors or groups of mirrors 416a . . . 416n as the number of input channels (which transmit the M 414a . . . 414n beams). The first mirror array 404 directs the beams 414a . . . 414n onto the second mirror array 408. For example, the optical and trap controller 220 dynamically commands the actuators 418a . . . 418n coupled to the mirrors or groups of mirrors 416a . . . 416n to reposition the mirrors or groups of mirrors 416a . . . 416n to direct the beams 414a . . . 414n onto particular mirrors in the second mirror array 408. This repositioning may occur on the microsecond scale. Directing beams 414a . . . 414n by the first mirror array 404 onto specific mirrors 520a . . . 520n of the second mirror array selects a particular output channel for each of the beams 614a . . . 614n.

In some aspects, one or more optical elements or optical relays may be positioned between the first mirror array 404 and the second mirror array 408. In such aspects, the optical elements or optical arrays may be or include 4F optical relays or 2F-2F relays configured to manipulate the M beams. Each of the M beams can be directed to a particular mirror 520a . . . 520n of the second mirror array 408.

The second mirror array 408 includes a number N of mirrors or groups of mirrors 420a . . . 420n that correspond to the number N of ions 272a . . . 272n. The optical and trap controller 220 may command one or more of the actuators 422a . . . 422n to reposition one or more of the mirrors or groups of mirrors 420 . . . 420n to change an angle of one or more of the beams 614a . . . 614n.

The beams 614a . . . 614n then travel to the second pair of mirror arrays 608. The second pair of mirror arrays 608 corrects distortion, for example compensating for the tilt angle of the beams 614a . . . 614n introduced by the first pair of mirror arrays 604. The first mirror array 504 in the second pair of mirror arrays 608 may receive the beams 614a-614n exiting the N mirrors of the second mirror array 408 of the first pair of mirror arrays 604. The mirrors or groups of mirrors 520a . . . 520n of the first mirror array 504 may receive the beams 614a . . . 614n. The optical and trap controller 220 commands the actuators 522a . . . 522n coupled to the mirrors or groups of mirrors 520a . . . 520n to reposition the beams 614a . . . 614n to correct tilt. The optical and trap controller 220 may be configured to command the actuators 526a . . . 526n coupled to the mirrors 524a . . . 524n to reposition the mirrors or groups of mirrors 524a . . . 524n in response to determining that the beams 614a . . . 614n are not hitting the ions 272a . . . 272n as desired.

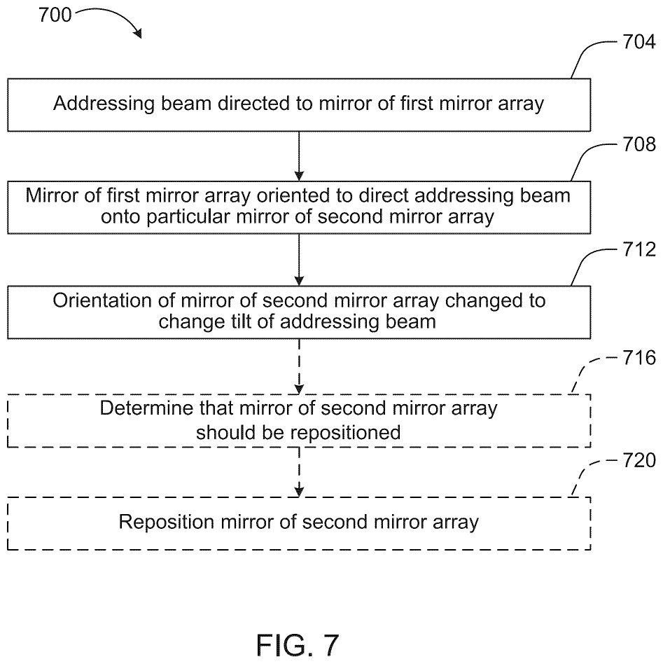

FIG. 7 illustrates a method 700 for directing (or redirecting) one or more beams 414a . . . 414n onto the trapped ions 272a . . . 272n. Although the method 700 is described with regard to the first beam 414a and particular mirrors of the first and second mirror arrays 404, 408, the method 700 can be used for any of the beams 414a . . . 414n and may involve any of the mirrors in the first and second mirror arrays 404, 408. Further, although the method 700 is described with regard to the system 400 of FIG. 4, the method 700 can also be used in the system 500 of FIG. 5 and the system 600 of FIG. 6. At 704, a first beam 414a is directed onto a first mirror 416a of a first mirror array 404. At 708, the first mirror 420a is oriented to direct the first beam 414a onto the first mirror 420a of the second mirror array 408, to direct the beam 414a to a particular output channel configured to address a particular trapped ion 272a. For example, the actuator 418a coupled to the first mirror 416a may be configured to position (or reposition) the first mirror 416a such that the first beam 414a is directed onto the first mirror 420a of the second mirror array 408. At 712, the orientation of second mirror 420a may be changed to adjust the tilt of the beam 414a to reposition the beam 414a relative to the trapped ion 272n. For example, the actuator 422a coupled to the first mirror 420a of the second mirror array 408 may be configured to position (or reposition) the first mirror 420a of the second mirror array 408 to adjust the tilt of the beam 414a relative to the trapped ion 272n. At 716, which may be optional, it is determined that the mirror 420a should be repositioned. This may be determined in response to determining that the particular ion 272n is receiving less input than other ions 272a . . . 272n-1, is responding more slowly when flipping the qubits with the addressing beams 414a, has more intensity than is expected to be needed to perform an operation with the qubits, and so forth. At 720, which may be optional, the orientation of the second mirror 420a may be changed to adjust the tilt of the beam 414a to reposition the beam 414a relative to the trapped ion 272n.

It is noted that according to an exemplary aspect, 704-708 may be repeated to switch the beam 414a to a different second mirror 420b . . . 420n to direct the beam 414a to a different output channel aligned with a different trapped ion 272a . . . 272n-1.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A quantum information processing (QIP) system including:
a laser source configured to produce one or more addressing beams;
a first mirror array configured to switch the one or more addressing beams between one or more channels, wherein each of the one or more channels is aligned with one or more qubits in an ion trap; and
a second mirror array,
wherein the first mirror array is configured to direct the one or more addressing beams to the second mirror array, and
wherein the second mirror array is configured to change a tilt of the one or more addressing beams relative to the one or more qubits in an ion trap.

2. The QIP system of claim 1, wherein the first mirror array comprises a first plurality of mirrors, and wherein the QIP system further comprises a first plurality of actuators configured to reposition the first plurality of mirrors to adjust a position of the one or more addressing beams.

3. The QIP system of claim 2, wherein the first plurality of actuators is configured to actuate the first plurality of mirrors on the microsecond scale.

4. The QIP system of claim 3, wherein the first plurality of actuators includes microelectromechanical systems (MEMS) actuators.

5. The QIP system of claim 1, wherein the second plurality of actuators is configured to actuate the second plurality of mirrors during a configuration sequence or to compensate for drift.

6. The QIP system of claim 1, wherein an amount of the one or more addressing beams is different than an amount of the one or more channels.

7. The QIP system of claim 1, wherein the second mirror array includes a plurality of mirrors, and wherein each mirror of the plurality of mirrors is aligned with a particular one of the one or more channels.

8. The QIP system of claim 1, further comprising:
a third mirror array positioned between the second mirror array and the ion trap, and wherein the second mirror array is configured to direct the one or more addressing beams to the third mirror array, and wherein the third mirror array is configured to change a position of the one or more addressing beams relative to the one or more qubits in the ion trap; and
a fourth mirror array positioned between the third mirror array and the ion trap, and wherein the third mirror array is configured to direct the one or more addressing beams to the fourth mirror array, and wherein the third mirror array is configured to change a tilt of the one or more addressing beams relative to the one or more qubits in the ion trap.

9. The QIP system of claim 7, wherein the third and fourth mirror arrays are configured to compensate for aberrations or drift in the QIP system.

10. A quantum information processing (QIP) system including:
a laser source configured to produce one or more addressing beams;
a first mirror array configured to change a position of the one or more addressing beams relative to one or more qubits in an ion trap; and
a second mirror array,
wherein the first mirror array is configured to direct the one or more addressing beams to the second mirror array, and
wherein the second mirror array is configured to change a tilt of the one or more addressing beams relative to the one or more qubits in the ion trap.

11. The QIP system of claim 10, wherein the first and second mirror arrays are configured to compensate for aberrations or drift in the QIP system.

12. The QIP system of claim 10, wherein an amount of the one or more addressing beams is the same as an amount of the one or more channels.

13. The QIP system of claim 10, further comprising:
a third mirror array configured to switch the one or more addressing beams between one or more channels, wherein each of the one or more channels is aligned with the one or more qubits in the ion trap; and
a fourth mirror array, wherein the third mirror array is configured to direct the one or more addressing beams to the fourth mirror array, and wherein the fourth mirror array is configured change a tilt of the one or more addressing beams relative to the one or more qubits in the ion trap, and wherein the fourth mirror array is configured to direct the one or more addressing beams to the first mirror array.

14. A quantum information processing (QIP) system including a processor and a memory, the processor configured to execute computer executable instructions in the memory to:
command one or more first actuators coupled to a first mirror away to switch one or more addressing beams produced by a laser source between one or more channels, wherein each of the one or more channels is aligned with one or more qubits in an ion trap and wherein the first mirror array is configured to direct the one or more addressing beams to a second mirror array; and
command one or more second actuators coupled to a second mirror array to reposition the one or more addressing beams to change a tilt of the one or more addressing beams relative to one or more qubits in an ion trap.

15. The QIP system of claim 14, wherein the instructions further comprise commanding at a portion of the first actuators to reposition a a first plurality of mirrors of the first mirror array to adjust a position of one of the one or more addressing beams.

16. The QIP system of claim 15, wherein the first plurality of mirrors is repositioned on the microsecond scale.

17. The QIP system of claim 14, wherein the second plurality of mirrors is repositioned during a configuration sequence or to compensate for drift.

18. The QIP system of claim 14, wherein the second mirror array includes a plurality of mirrors, and wherein each mirror of the plurality of mirrors is aligned with a particular one of the one or more channels.

19. The QIP system of claim 14, wherein the instructions further comprise:
determining that a particular qubit is one or more of receiving less input than other qubits of the one or more qubits, responding more slowly than other qubits of the one or more qubits, has more intensity than is expected to be needed to perform an operation;
commanding a portion of the second actuators to reposition a plurality of mirrors of the second mirror array to reposition the particular one or more addressing beam configured to address the particular qubit.

20. The QIP system of claim 14, wherein the one or more first actuators and the one or more second actuators include microelectromechanical systems actuators.
